(19) United States
(12) Patent Application Publication
(10) Pub. No.: US 2010/0310332 A1
(43) Pub. Date: Dec. 9, 2010

(54) QUICK CORE REMOVAL HOLE CUTTING PRODUCT

(76) Inventor: Henry Serba, Chicago, IL (US)

Correspondence Address: SABRE TECHNICAL SERVICES CORP., 4917 N. DAMEN AVE., CHICAGO, IL, 60625, US

(21) Appl. No.: 12/793,083

(22) Filed: Jun. 3, 2010

Related U.S. Application Data
(60) Provisional application No. 61/185,236, filed on Jun. 9, 2009.

(51) Int. Cl. B23B 51/04

(52) U.S. Cl. 408/206

(57) ABSTRACT

The invention comprises a hole-cutting product with a cup-shaped body and a cutting edge along an open end. The cutting edge comprises a diminishing-radius portion for removing an annular band of material from a workpiece and produces a core remainder in the body that is easy to remove.

The invention is a hole-cutting product configured with a closed curvilinear cutting edge aligned around an axis of rotation. The cutting edge is configured to facilitate easy core removal from within the product after cutting holes. The invention can be used with rotational power sources such as a power drill.

A conventional hole saw has a cutting edge in the shape of a circle around a central axis. In the conventional hole saw, the cutting edge is positioned at the open end of a cylindrical body, with the end opposite the open end being closed. In use, the conventional hole saw rotates about the central axis as it cuts into a workpiece. The conventional saw makes an annular cut and removes a substantially cylindrical core from the workpiece, leaving behind a circular hole. The conventional hole saw can be used with a power drill to provide rotational energy. Hole saws are used for cutting large diameter holes in various materials such as wood, metal, plastic and other materials.

When cutting, a conventional hole saw can remove an annular band of material with a width substantially equal to a skirt wall thickness. Some conventional hole saws have outward-set teeth and inward-set teeth, and the width of the annular band removed by these holes saws can be the maximum separation between the outward-set teeth and the inward-set teeth.

After cutting, the core can be difficult to remove from the hole saw body due to a close tolerance between the outer diameter of the core and the inner diameter of the saw. Removal can be further impaired when the hole saw has a pilot drill positioned along the central axis. It is not unusual to have to pry the core from the conventional hole saw with a screwdriver or other tool.

### DRAWINGS

FIG. 1 is an isometric view of an embodiment of the hole-cutting product.

FIG. 2 is an end view of the embodiment.

FIG. 3 is a detail view within line 3-3.

FIG. 4 is a side view of the embodiment.

FIG. 5 is an isometric view of the embodiment and a power drill.

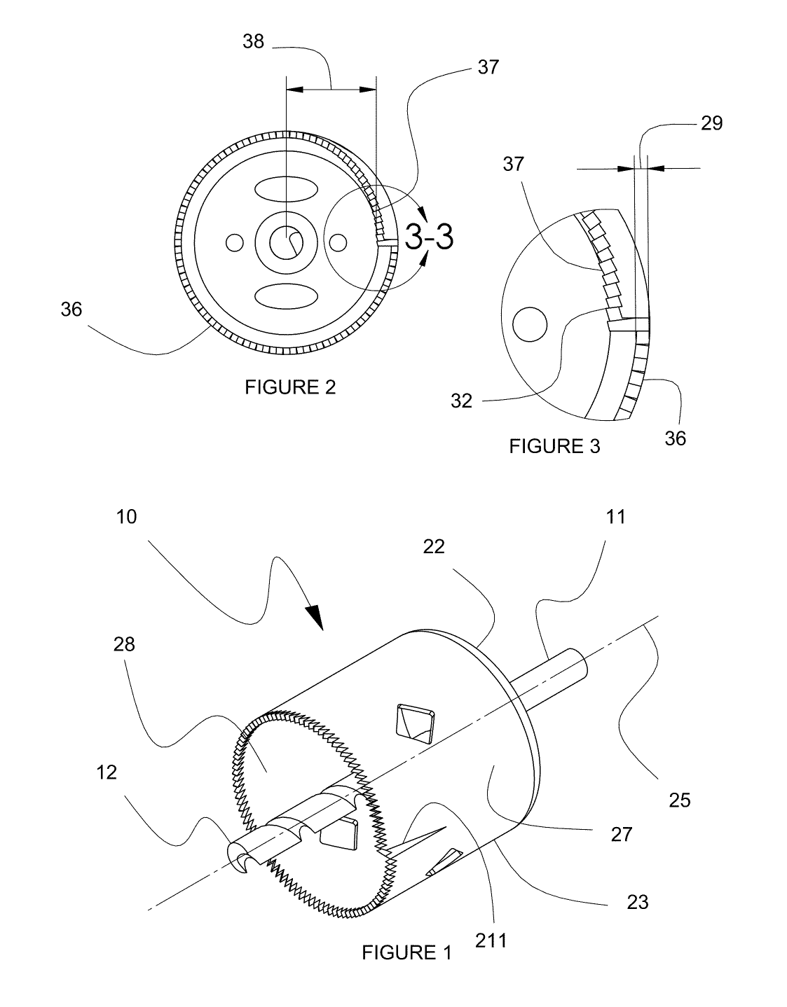

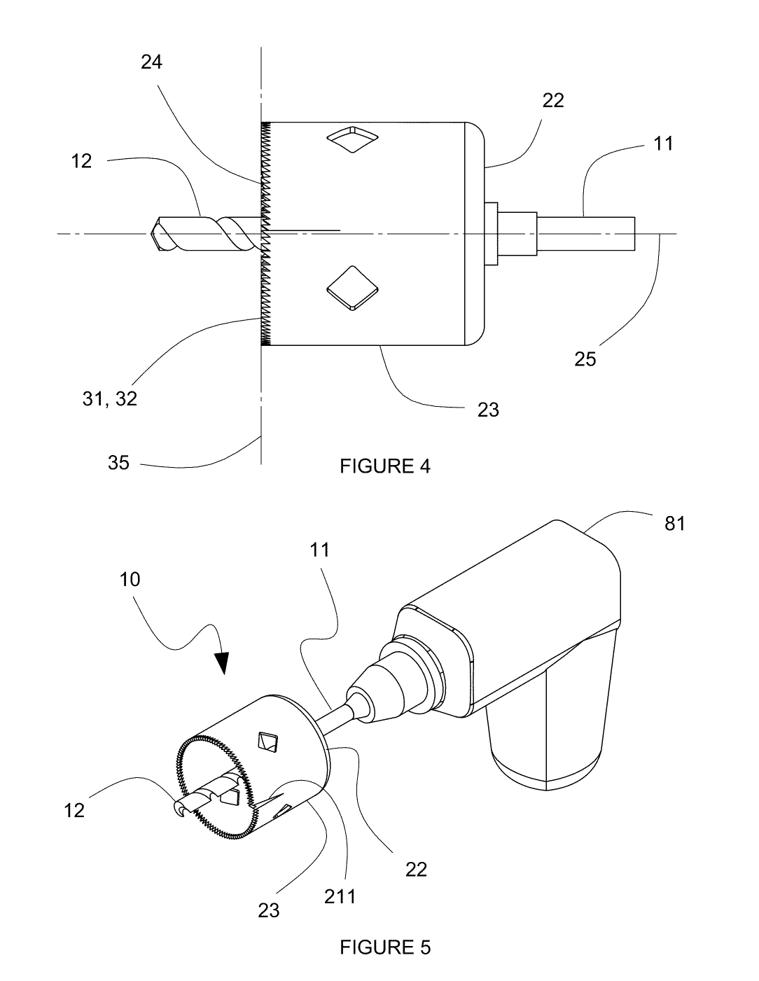

The hole-cutting product 10 can comprise a cup-shaped body with at least one open end. The body can comprise a substantially planar bottom 22 connected to a substantially cylindrical skirt 23. The skirt 23 can surround an axis of rotation 25.

The hole-cutting product 10 can comprise a shank 11 connected to the bottom 22 and extending away from the open end. The shank 11 can be coaxial to the axis 25.

The hole-cutting product 10 can comprise a pilot drill 12 connected to the bottom 22 and extending coaxially away from the shank 11 through the skirt 23. The pilot drill 12 and the shank 11 can be connected. The shank 11 can be a component of the pilot drill 12.

At least part of the skirt 23 can be a right, circular cylinder. The skirt can have an inner skirt surface 28 and an outer skirt surface 27. The inner skirt surface 28 and the outer skirt surface 27 can define a skirt wall thickness 29.

The skirt 23 and the bottom 22 can each have at least one through-penetration.

The hole-cutting product 10 can comprise a closed-curvilinear toothed cutting edge 31 connected to the skirt 23 at the open end of the skirt. The cutting product 10 cuts into a workpiece when the cutting edge 31 contacts the workpiece while rotating about the axis of rotation 25. When cutting, the cutting edge 31 removes material along a cut surface on the workpiece.

The cutting edge 31 can have a plurality of teeth arrayed along the cutting edge. The teeth can be substantially equally spaced apart. The teeth can be arrayed in groups where the groups are substantially equally spaced apart. The teeth can be irregularly spaced apart along the cutting edge 31 and can be arrayed in combinations of equally spaced and irregularly spaced teeth.

The plurality of teeth can comprise an inward-set tooth and an outward-set tooth. The inward-set tooth can angle inward towards the axis 25 as it extends towards the open end. The outward-set tooth can angle outward away from the axis 25 as it extends toward the open end 24. When cutting, the outward-set tooth and the inward-set tooth can widen the cutting surface.

The cutting edge 31 can be positioned substantially on a cutting plane 35 where the cutting plane 35 is perpendicular to the axis 25. Alternatively, the cutting plane 35

[symbol]

The closed-curvilinear cutting edge 31 can have a constant-radius portion 36 where the constant-radius portion 36 is separated from the axis 25 by an unvarying distance. When the cutting product 10 rotates about the axis 25, the teeth positioned on the constant-radius portion 36 move on a single circular path.

The closed-curvilinear cutting edge 31 can have a diminishing-radius portion 37 connected to the constant-radius portion 36. The diminishing-radius portion 37 can extend towards the axis 25 from the constant-radius portion 36 to a minimum radius 38. The teeth positioned on the diminishing-radius portion 37 can be adjacent the teeth positioned on the constant-radius portion 36 where the diminishing-radius portion 37 connects to the constant-radius portion 36. The teeth positioned on the diminishing-radius portion 37 can be positioned progressively nearer to the axis 25 as the diminishing-radius portion 37 extends towards the axis 25. When the cutting product 10 rotates about the axis 25, the teeth positioned on the diminishing-radius portion 37 each move on concentric circular paths.

When cutting a workpiece with the hole-cutting product 10, the diminishing-radius portion 37 can remove an annular band of material from the workpiece and reduce an outer diameter of the core to substantially the position of an innermost tooth on the diminishing-radius portion 37 of the cutting edge 31. Reducing the outer diameter of the core with respect to the inner skirt surface 28 creates a core that fits loosely within the skirt 23. A loose-fitting core facilitates easy core removal from the hole-cutting product 10.

The diminishing-radius portion 37 of the cutting edge 31 can comprise between 15% and 80% of the cutting edge 31. Experimentation has shown that good results are obtained when the diminishing-radius portion 37 comprises approximately 30% of the cutting edge 31.

Experimentation has shown that good results are obtained when the innermost tooth is spaced apart from the inside skirt surface 28 by approximately three times the skirt wall thickness 29. Alternatively, the innermost tooth can be spaced apart from the inside skirt surface 28 by various distances, both larger and smaller than three times the skirt wall thickness 29.

The skirt 23 can have a transition component 211 that extends from the cutting edge 31 towards the bottom 22 substantially along the axis 25. The skirt 23 can transition from the cutting edge 31, including the constant-radius portion 36 and the diminishing-radius portion 37, to the right, circular cylinder part of the skirt 23. The transition component 211 can extend outwards from the diminishing-radius portion 37 of the cutting edge 31 and away from the axis 25 to increase looseness away from the diminishing-radius portion 37. Again, increasing looseness between the core and the cutting product 10 facilitates easy core removal from the cutting product 10.

Configuring the cutting edge 31 so that the minimum radius 38 coincides with an inward-set tooth further facilitates loose fit. Such a configuration provides a single point—the inward-set tooth—at the minimum radius 38, so that the core encounters minimal contact at removal.

The cutting edge 31 including the diminishing-radius portion 37 can be fabricated in various ways including forming, casting, cutting to deform followed by welding to reconnect, forging, and various other manufacturing methods.

The cutting edge 31 can include interruptions along the cutting edge 31, including interruptions along the constant-radius portion 36 and interruptions along the diminishing-radius portion 37.

The plurality of teeth can be steel. The plurality of teeth can be hardened steel and can be tempered steel. The plurality of teeth can be various cutting materials including ceramic, diamond, carbide, and other materials and combinations thereof.

Claimed is:

1. A hole-cutting product comprising:
a closed-curvilinear toothed cutting edge enclosing an axis of rotation;
the cutting edge being positioned substantially on a cutting plane where the cutting plane is perpendicular to the axis;
the cutting edge having a diminishing-radius portion connected to a constant-radius portion;
the diminishing-radius portion extending increasingly towards the axis from the constant-radius portion;
a skirt connected to the cutting edge and enclosing the axis of rotation;
the skirt extending away from the cutting edge along the axis;
the skirt transitioning in shape from the closed-curvilinear cutting edge to a substantially circular cylinder as the skirt extends away from the cutting edge.

2. The product of claim 1 wherein the skirt transitions in shape from the closed-curvilinear cutting edge to a substantially circular cylinder as the skirt extends away from the cutting edge over a transition portion.

3. The product of claim 1 wherein the closed-curvilinear toothed cutting edge further comprises:
a plurality of cutting teeth arrayed along the cutting edge,
the plurality of cutting teeth comprising alternating inward-set teeth and outward-set teeth, where an inward-set tooth is angled inwards towards the axis of rotation and where an outward-set tooth is angled outwards away from the axis of rotation;
and wherein the diminishing-radius portion has an inward-set tooth at a minimum radius.
